(19) United States
(12) Patent Application Publication
(10) Pub. No.: US 2005/0039542 A1
(43) Pub. Date: Feb. 24, 2005

(54) Device for detecting the stress distribution of metal band loaded by band tension

(76) Inventors: Axel Berger, Kaarst (DE); Frank Berger, Hullhorst (DE)

Correspondence Address: PROSKAUER ROSE LLP;PATENT DEPARTMENT, 1585 BROADWAY, NEW YORK, NY, 10036-8299, US

(21) Appl. No.: 10/492,044

(22) PCT Filed: Oct. 7, 2002
(86) PCT No.: PCT/EP02/11204

(30) Foreign Application Priority Data
Oct. 5, 2001 (DE) 101 49 240.5
Jan. 22, 2002 (DE) 102 02 413.8

(51) Int. Cl. G01N 3/08

(52) U.S. Cl. 73/818

(57) ABSTRACT

The invention relates to a device for detecting the stress distribution of metal strips stressed by tension of the strip, comprising a measuring roller (10-50), comprising at least one receptacle (2) formed in the measuring roller (10-50), comprising a measuring sensor (6) which sits in the receptacle (2), comprising a force-transmitting element (5) fitted in the receptacle (2), which has a loading shoulder (5b) acting on the measuring sensor (6), said loading shoulder's (5b) cross-sectional area is smaller than the cross-sectional area of the receptacle (2), and which has a supporting shoulder (5c) which is constructed on the side of the loading shoulder (5b) associated with the outside of the measuring roller (10-50) and which has a smaller cross-sectional area than the loading shoulder (5b), and comprising a cover (7) which is pressed in to the opening of the receptacle (2) and seals this completely, whose outwardly directed surface is arranged substantially flush to the circumferential surface (8) of the measuring roller (10-50) and which is supported on the supporting shoulder (5c) of the force-transmitting element (5).

The invention relates to a device for detecting the stress distribution of metal strips stressed by tension of the strip. Such devices are used, for example, to measure stresses appearing in the respectively processed strip during cold rolling and to derive control signals therefrom for devices which regulate the distribution of the tensile forces acting on the strip.

In order to be able to measure the stress distribution, the metal strip is guided around the measuring roller. The measurement is then made by force measuring sensors located in the roller with which the strip is scanned. The strip deflecting forces acting on the measuring roller result in bending stresses in the measuring roller which cause deformation of the cross-section of the measuring roller.

A fundamental problem with such detection of the stress distribution is the risk of damage to the sensors and the fact that contamination of the measuring sensors occurs. Thus, in the past attempts have been made to screen the measuring sensors from the environment such that on the one hand, an optimal measurement accuracy is achieved and on the other hand, destruction of the sensors or any contamination of the measuring sensors having a negative influence on the measurement result is prevented.

An attempt of this kind is known from DE 26 30 410 A1. In this measuring roller the measuring sensors are inserted in receptacles formed in the measuring rollers. In order to protect the measuring sensors, the measuring roller is covered with a steel jacket which has been shrunk on. In this way, comprehensive protection of the measuring sensors against external influences is provided. In practice, however, it is found that the deformation of the measuring roller accompanying the loading of the measuring roller during operation results in warping of the steel jacket. This warping directly changes the deformation behaviour of the measuring roller so that the measuring sensors provide a falsified image of the actual stress load.

An attempt has been made to alleviate the disturbances caused by encasing the measuring roller by arranging a plurality of sensors distributed around the circumference of the measuring roller and wired together such that the perturbing signals produced by the non-uniform deformation of casing and measuring roller at least partly compensate for one another (DE-AS 15 73 407). In practice, however, it has been shown that even with such an arrangement of the measuring sensors, no measuring signals which meet the high requirements for measurement accuracy can be obtained.

For this reason, it has been proposed in DE 42 36 657 A1 that the receptacle formed in the measuring roller should be respectively partitioned against the environment by a cover constructed as a solid body which sits in the receptacle with play and is supported on the measuring sensor. In this case, the outer surface of the cover associated with the environment is adapted to the contour of the measuring roller so that in the ready-assembled position this outer surface ends substantially flush with the circumferential surface of the measuring roller.

With such partitioning of the receptacle, disturbances are certainly avoided such as could not be prevented in the previously described prior art known from DE 26 30 410 A1 or DE-AS 15 73 407. Instead however, the risk must be accepted that contamination settles in the gap necessarily present between the cover and the wall of the receptacle surrounding it. These accumulations of contamination impede the free mobility of the covering body in the receptacle so that the measuring roller again only delivers measuring signals which do not reflect the loads actually acting on the measuring roller.

In DE 196 16 980 A1 it has been proposed that the risk of falsification of the measurement result which exists in the previously described prior art can be prevented by sealing the gap between the covering body and the walls of the receptacle using a synthetic material. However, this measure also cannot prevent particles entrained by the processed strip from becoming pressed into the synthetic material. These particles thus result in a force diversion which restricts the mobility of the covering body and accordingly falsifies the measurement result.

Starting from the prior art described hereinbefore, it was the object of the invention to provide a device with which the stresses formed in a metal strip can be detected reliably and with a minimised risk of perturbing influences.

This object is solved by a device for detecting the stress distribution of metal strips stressed by tension of the strip, which is provided with a measuring roller, at least one receptacle formed in the measuring roller, a measuring sensor which sits in the receptacle, a force-transmitting element fitted in the receptacle, which has a loading shoulder acting on the measuring sensor, said loading shoulder's cross-sectional area is smaller than the diameter of the receptacle, and which has a supporting shoulder which is constructed on the side of the loading shoulder associated with the outside of the measuring roller and which has a smaller diameter than that of the loading shoulder, and is provided with a cover which is pressed into the opening of the receptacle and seals said receptacle completely, said cover's outwardly directed surface is arranged substantially flush to the circumferential surface of the measuring roller and which cover is supported on the supporting shoulder of the force-transmitting element.

According to the invention, the receptacle which respectively receives the measuring sensor is sealed by a cover which is inserted into the opening of the receptacle under pressing. In this way, a completely sealed partitioning of the receptacle and the measuring sensor arranged therein with respect to particles and similar contamination is produced. At the same time, since the cover is supported on the force-transmitting element and the force-transmitting element acting on the measuring sensor is suitably connected to the measuring roller, it is thereby ensured that the forces acting on the cover are transmitted to the measuring sensor correctly and without any falsifications by external influences and from said measuring sensor are supplied to a measuring and control device as an exact image of the actual loadings.

The pressing with which the cover sits in the opening of the receptacle can easily be dimensioned so as to ensure a permanently secure sealing of the receptacle at the same time with a substantially jointless transition between the circumferential surface of the measuring roller and the cover. In this way, on the one hand, loose particles which could falsify the measurement result are reliably prevented from settling in the area of the cover. On the other hand, the press fit ensures that the surface of the respectively processed strip is not damaged by accumulations of dirt particles on the circumferential surface of the measuring roller.

The cover can be pressed into the receptacle in a conventional fashion by shrinking the cover into the receptacle. Alternatively, shaped elements such as sloping wedges or the like can be provided to facilitate mechanically assisted pressing of the cover into the receptacle. The pressing acting on the cover produces a force by which the measuring sensor is pre-stressed in a defined fashion also in the non-operative state. It is thus expedient to determine the forces produced during pressing in of the cover by means of the measuring sensor in order to thus obtain a clear prediction of the actual loading state of the sensor in the ready assembled state.

An important feature of the invention is that the cover is respectively supported on the force-transmitting element via a supporting section whose cross-sectional area is smaller than the cross-sectional area of the force-transmitting element in the area of the loading shoulder, via which the loading of the measuring sensor is accomplished. In this way, it is ensured that the forces acting on the cover are introduced into the force-transmitting element in a concentrated fashion and transferred from said element onto the measuring sensor. This makes it possible for the measuring sensor, the shape of the force-transmitting element and the shape of the cover to be matched to one another such that a continuously optimally exact measurement result is achieved.

According to another embodiment of the invention the measuring sensor is constructed as ring-shaped. With such a ring-shaped measuring sensor the loads produced during operation of the measuring roller can be determined particularly reliably.

This applies particularly when the force-transmitting element has a shaft section having one end connected fixedly to the measuring roller. The loads of the measuring roller corresponding to the stresses in the strip guided around the measuring roller can thus be determined particularly clearly.

The loading shoulder is preferably constructed as a collar which encircles the shaft section so that the measuring sensor and the force-transmitting element can be arranged coaxially to one another and the loading shoulder can act with its underside facing away from the outside of the measuring roller on the measuring sensor. With this shape and arrangement of the measuring sensor and the force-transmitting element it is ensured that the loads produced during operation of the measuring roller are correctly detected by the measuring sensor in terms of their direction of action and distribution.

Generally, in order to achieve problem-free detection of the measurement signals, it is necessary to pre-stress the measuring system formed from the cover, force-transmitting element and measuring sensor. An embodiment of the invention which is particularly easy to assemble in this respect is characterised in that the cover and the force-transmitting element are constructed in one piece. In this way, it is possible to insert the force-transmitting element and the cover into the receptacle at the same time. The force with which the measuring sensor is pre-stressed can be set exactly by the depth over which the body formed of the force-transmitting element and the covering element is inserted into the receptacle. In this case, shaped elements such as a square or hexagonal head can be provided on the cover, to which an assembly tool can be applied. After completing the assembly work, these assembly tools can be removed from the cover so as to ensure a proper transition from the circumferential surface of the measuring roller to the free outer surface of the cover.

A multi-part design of the assembly formed from the cover and the force-transmitting element has the advantage that different materials can be used to manufacture the cover and the force-transmitting element. Thus, the cover can be made of a particularly wear-resistant material whereas the shaft can consist of a tough material which is especially well capable of absorbing the loads produced during operation of the measuring roller. In this case, a simplified assembly can be achieved despite the multipart design since the loading shoulder, the supporting shoulder and the cover integrally form a body which is coupled to the measuring roller via a shaft detachably connected to the body. For the same purpose, it is feasible to construct only the cover and the supporting shoulder as an integral body which is again detachably supported on the shaft bearing the loading shoulder.

The problem-free detection of the forces of the measuring roller which reflect the stress distribution in the strip being inspected can be additionally assisted by the fact that the force-transmitting element has shaped elements which bring about a directional introduction of forces acting on the cover onto the force-transmitting element. These shaped elements can, for example, be constructed as notches, recesses, grooves or the like which bring about a specific weakening of the force-transmitting element and/or the cover and specify a correspondingly preferred direction of deformation of the force transmission.

If the measuring roller is used in an environment severely stressed by liquids, such as oils or media having comparable creep properties, the risk of such liquids penetrating into the receptacle existing despite the cover being pressed tightly into the receptacle, can be avoided by arranging a sealing element between the force-transmitting element and the wall of the receptacle surrounding the force transmitting element, through which a space between the cover and the sealing element is sealed with respect to the measuring sensor.

Another advantageous embodiment of the invention consists in the fact that the cover is connected to the force-transmitting element by means of a press connection. It has surprisingly been found that in this manner, which is especially easy to produce, it can be ensured, that the forces acting on the cover can be transmitted to the measuring sensor correctly and without any falsifications by external influences and from there supplied to a measuring and control device as an exact image of the actual loads.

Further advantageous embodiments of the invention are given in the dependent claims and are explained in detail below with reference to a drawing which shows an exemplary embodiment. In the figures:

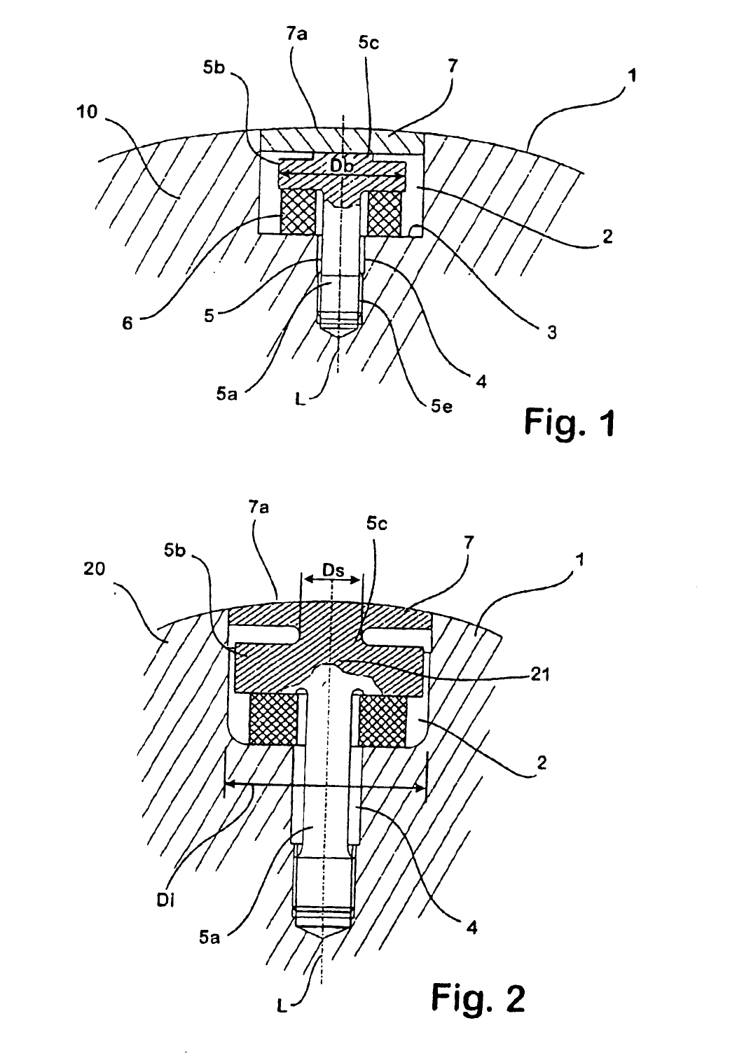

FIG. 1 is a schematic cross-sectional view of a first measuring roller,

FIG. 2 is a schematic cross-sectional view of a second measuring roller,

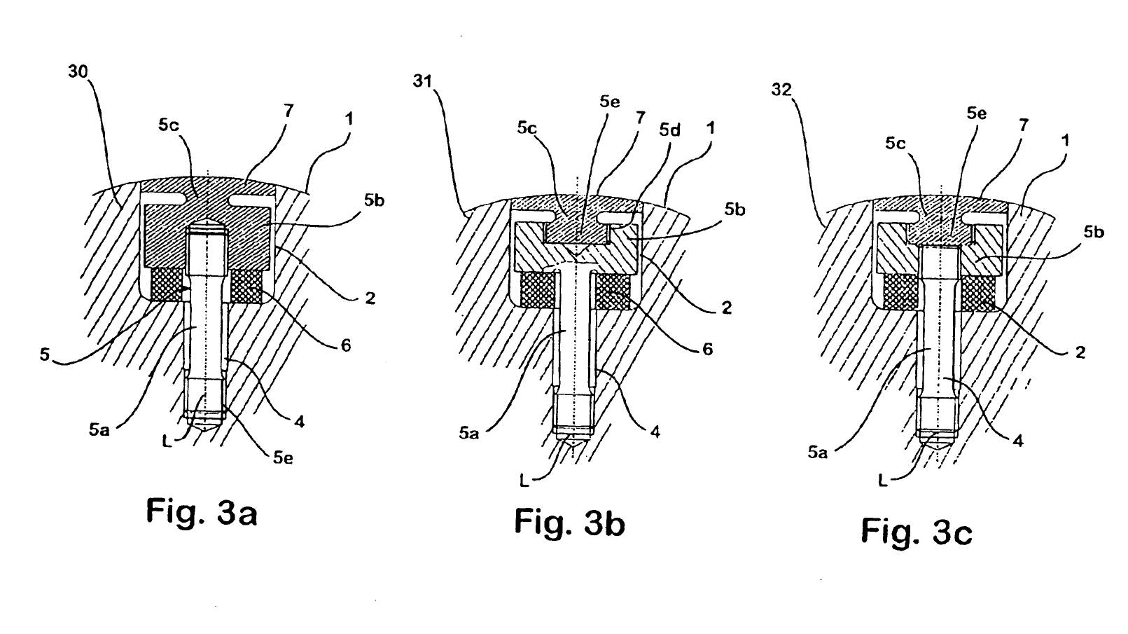

FIG. 3a-3b is a schematic cross-sectional view of three other variants of measuring rollers,

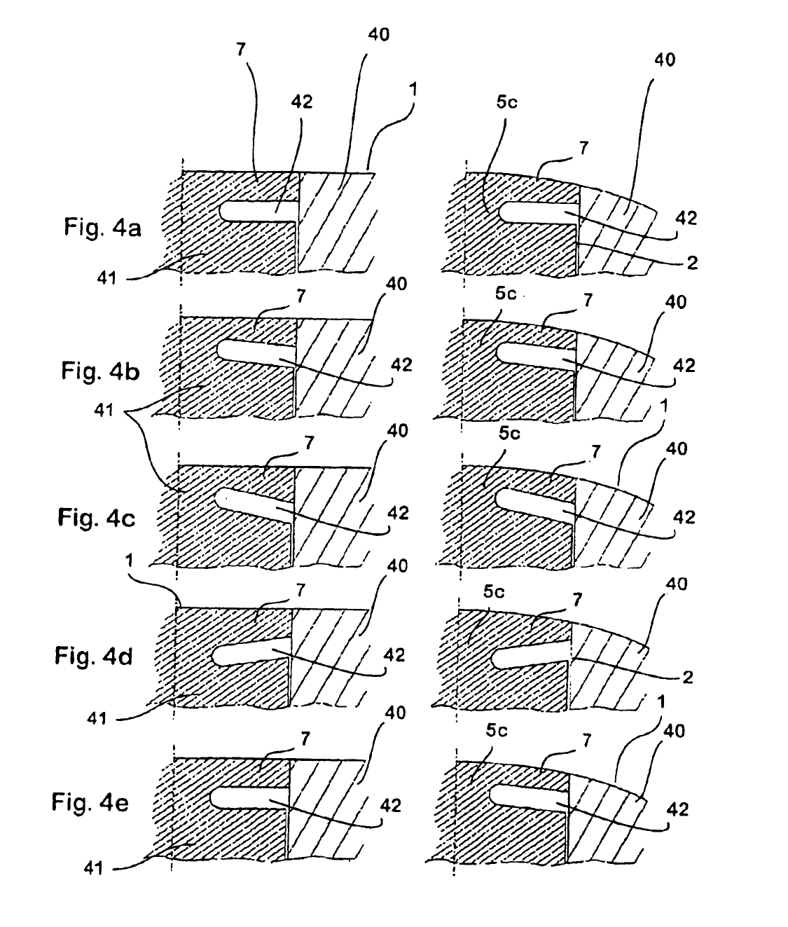

FIG. 4a-4e are schematic longitudinal (left half of the respective figures) and cross-sectional views (right half of the respective figure) of various measuring rollers.

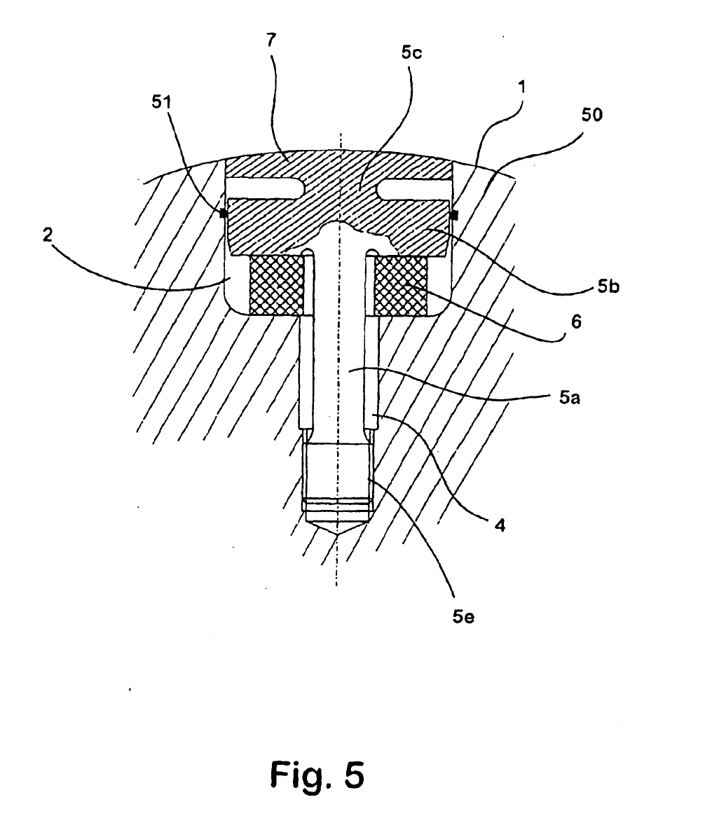

FIG. 5 is a schematic cross-sectional view of a fifth measuring roller.

The measuring rollers 10, 20, 30, 31, 32, 40 and 50 shown in FIGS. 1 to 5 are typically used in cold rolling mills. The steel strip processed in the cold rolling mill, which is not shown here, is guided over the circumferential surface 1 of the measuring rollers 10, 20, 30, 31, 32, 40 and 50.

The measuring rollers 10, 20, 30, 31, 32, 40 and 50, respectively have at least one circular cross-section receptacle 2 constructed in the fashion of a blind hole, in whose base 3 there is additionally respectively formed a bore 4 provided with an internal thread adjacent to its bottom and aligned coaxially to the longitudinal axis L of the receptacle 2.

A shaft 5a with a threaded section formed at one end is screwed into the bore 4. At its other end associated with the opening of the receptacle 2, said shaft 5a bears a loading shoulder 5b which is constructed as a collar which encircles said shaft 5a. In this case, the diameter Db of the loading shoulder 5b is smaller than the internal diameter Di of the receptacle 2.

A supporting shoulder 5c also having a circular cross-section is constructed coaxially to the longitudinal axis L on the upper side of the loading shoulder 5b associated with the opening of the receptacle 2. The diameter Ds of this supporting shoulder 5c is smaller than the diameter Db of the loading shoulder 5b so that the supporting shoulder 5c has a smaller cross-sectional area than the loading shoulder.

The shaft 5a, the loading shoulder 5b carried by it and the supporting shoulder 5c jointly form a force-transmitting element 5 via which a measuring sensor 6 constructed as ring-shaped and arranged coaxially to the longitudinal axis L is loaded. For this purpose, the measuring sensor 6 is tensioned between the loading shoulder 5b and the base 3 of the receptacle 2 such that the loading shoulder 5b acts on the measuring sensor 6 with its underside facing away from the opening of the receptacle 2.

The opening of the receptacle 2 is respectively closed by a circular cover 7 aligned coaxially to the longitudinal axis L, which is pressed into the receptacle 2. The cover 7 is supported on its underside associated with the interior of the receptacle 2 on the supporting shoulder 5c of the force-transmitting element 5.

The pressing acting between the circumferential wall of the receptacle 2 and the cover 7 is designed such that, on the one hand, the cover 7 is held securely in the opening of the receptacle 2 under the forces produced during operation of the measuring rollers 10, 20, 30, 31, 32, 40 and 50. On the other hand, the cover 7 is in this way pre-stressed with a defined force which is introduced into the force-transmitting elements and transmitted from said element to the measuring sensor 6.

The profile of the outer surface 7a of the cover 7 is matched to the profile of the circumferential surface of the respective measuring roller 10, 20, 30, 31, 32, 40 and 50 so that the cover 7 fits flush into the receptacle 2 and goes over into the circumferential surface 1 substantially free from gaps. The matching of the cover 7 to the profile of the circumferential surface 1 can be prepared by suitable shaping already during the manufacture of the cover 7 and completed by machining treatment after the cover 7 has been assembled.

In the exemplary embodiment shown in FIG. 1, the force-transmitting element 5 is constructed as an integral body with its shaft 5a, its loading shoulder 5b and its supporting shoulder 5c. The cover 7 on the other hand is shrunk into the opening of the receptacle 2 as an independent body in an inherently known fashion. The pressing present between the measuring roller 10 and the cover 7 after equalising the temperature can be detected by the measuring sensor 6 when the measuring roller 10 is unloaded and used to determine a defined initial state of the measuring sensor 6. As a result of the pre-stressing of the cover 7, a secure contact between the underside of the cover 7 and the supporting shoulder 5c is additionally ensured.

In the exemplary embodiment shown in FIG. 2 the cover 7 as well as the force-transmitting element 5 with its supporting shoulder 5c, loading shoulder 7b and shaft 5a form an integral body 21. Separate pre-stressing of the cover 7 is not necessary in this exemplary embodiment. Instead, a shaped element, not shown: here, can be formed on the cover 7 as an assembly aid, to which a tool can be applied to screw in the body 21. The circumferential edges of the cover 7 and/or the opening of the receptacle 2 are suitably bevelled so that as the body 21 is screwed in, its cover 7 is pressed into the receptacle 2. Alternatively or additionally to a bevelling of the edges, the pressing in of the cover into the opening can be assisted by cooling the body 21 and heating the measuring roller 20. After assembly has been completed, the assembly aid is removed from the cover 7 and the surface of the cover 7 is polished until its shape is matched to the shape of the circumferential surface 1.

FIGS. 3a to 3c show exemplary embodiments in which special requirements are imposed on the circumferential surface of the measuring roller 30, 31, 32, for example, with regard to surface hardness or surface roughness. In the case of these measuring rollers 30, 31, 32, the cover 7 pressed into the opening of the receptacle 2 must accordingly also have a particularly high hardness and wear resistance. The requirements imposed on the cover 7 thus run contrary to the requirements imposed on the shaft 5a of the force-transmitting element 5. Its material must have sufficient toughness in order to securely transmit the loads acting respectively on the measuring rollers 30, 31, 32 to the respective measuring sensor.

In order to meet these contradictory requirements, in the examples shown in FIGS. 3a to 3c, the cover 7 is made of a wear-resistant hard material and at least the shaft 5a of the force-transmitting element 5 is made of a tough material which has good deformability and thus transfers the deformations of the measuring roller better to the measuring sensor 6.

In the exemplary embodiment shown in FIG. 3a, the loading shoulder 5b, the supporting shoulder 5c and the cover 7 form a body which is screwed onto the end of the shaft 5a pointing towards the opening of the receptacle 2. In this example, it can be seen particularly clearly that the shaft 5a is guided freely in the bore 4 formed in the base of the receptacle 2 over a large part of its length, i.e., without contact with the side walls of the bore and is only held fixedly in the bore 4 at its end section. In this way, the shaft 5a can be deformed under loading over a large length.

In the exemplary embodiment shown in FIG. 3b the cover 7 with the supporting shoulder 5c on the one hand and the shaft 5a with the loading shoulder 5b on the other hand respectively form an integrally constructed body. In this case, in the side of the loading shoulder 5b facing away from the shaft 5a there is formed an inner thread 5d arranged coaxially to the longitudinal axis L into which a screw section 5e formed on the supporting section 5c is screwed.

In the exemplary embodiment shown in FIG. 3c, as shown in FIG. 3b, the cover 7 forms an integral body with the supporting shoulder 5c on which a screw section 5e is formed as in the exemplary embodiment according to FIG. 3b. The loading shoulder 5b of the force-transmitting element 5 on the other hand is constructed as an independent, nut-like component having internal threads formed respectively in its front sides. The screw section 5e is screwed into the upper of these internal threads in the assembly position whereas the end of the shaft 5a pointing towards the cover 7, which forms an independent component in this case, is screwed into the lower internal thread. The cover 7 with the supporting section 5c and the screw section 5d, the loading shoulder 5b and the shaft 5a consist in this case of different materials respectively optimally matched to the respectively acting loads.

The force transmission behaviour of the force-transmitting element 5 can be additionally influenced by suitably shaping the underside of the cover 7. This can be accomplished particularly easily by the cover 7 and the force-transmitting element 5 forming an integral body 41. In this case, a circumferential groove 42 can be formed in the body 41 whose alignment determines the thickness profile of the cover 7. The core of the body 41 remaining in the area of this groove then forms the supporting section 5c via which the cover 7 is supported.

The groove 42 can, for example, be produced in the form of a recess guided from the radial direction so that the groove 42 is aligned substantially normal to the longitudinal axis L. In this case, the cover has a constant thickness in the axial direction of the measuring roller whereas in the circumferential direction its thickness increases starting from the thin edge to the supporting section 5c (FIG. 4a).

If the groove 42 is incorporated in the body 41 at an angle such that it ascends starting from the circumference of the body towards the cover 7, a cover 7 can be produced having approximately constant thickness in the circumferential direction and increasing thickness in the axial direction starting from the supporting section 5c towards the edge of the cover 7. The increase in thickness is in this case determined by the angle at which the groove is directed into the body 41 (FIGS. 4b, 4c). In comparable fashion, by means of an arrangement of the groove 42 directed away from the cover at an angle starting from the circumference, it is possible to produce a cover 7 on the body 41, which said cover's thickness increasing in the area projecting over the supporting section 5c both in the axial direction as well as in the circumferential direction of the measuring roller 2 (FIG. 4d).

Finally, by using suitable CNC processing machines, the groove 42 can be guided such that a constant thickness is achieved in the region of the cover 7 projecting over the supporting section 5c, both in the axial and in the circumferential direction.

The embodiment shown in FIG. 5 corresponds to the exemplary embodiment shown in FIG. 2 with regard to the integral body formed by the cover 7, the supporting shoulder 5c, the loading shoulder 5b and the shaft 5a. In addition, a circumferential groove is formed in the inner wall of the receptacle 2 in which a ring seal 51 is located. The ring seal 51 at the same time abuts against the circumferential surface of the actuating shoulder 5b. In this way the space below the actuating shoulder 5b is protected against the penetration of penetrating oil and other fluids which penetrate into the receptacle 2 despite the cover 7 being pressed in tightly into the receptacle 2.

Reference Numbers

10,20 Measuring rollers
30,31,32 Measuring rollers
40,50 Measuring rollers
1 Circumferential surface
2 Receptacle
3 Base
4 Bore
5 Force-transmitting element
5a Shaft
5b Loading shoulder
5c Supporting shoulder
5d Inner thread
5e Screw section
6 Measuring sensor
7 Cover
7a Outer surface of cover 7
21 Body
41 Body
42 Groove
51 Ring seal
Db Diameter of the loading shoulder 5b
Di Internal diameter of the receptacle 2
Ds Diameter of supporting shoulder 5c
L Longitudinal axis of the receptacle 2

1. A device for detecting the stress distribution of metal strips stressed by tension of the strip
comprising a measuring roller,
comprising at least one receptacle formed in the measuring roller,
comprising a measuring sensor which sits in the receptacle,
comprising a force-transmitting element fitted in the receptacle, which has a loading shoulder acting on the measuring sensor, said loading shoulder's cross-sectional area is smaller than the cross-sectional area of the receptacle, and which has a supporting shoulder which is constructed on the side of the loading shoulder associated with the outside of the measuring roller, and which has a smaller cross-sectional area than the loading shoulder, and
comprising a cover which is pressed into the opening of the receptacle and completely seals said receptacle, said cover's outwardly directed surface is arranged substantially flush to the circumferential surface of the measuring roller and which cover is supported on the supporting shoulder of the force-transmitting element.

2. The device according to claim 1, wherein the force-transmitting element has one end fixedly connected to the measuring roller and has the loading shoulder at its other end.

3. The device according to claim 1 wherein the measuring sensor is constructed as ring-shaped.

4. The device according to claim 1, wherein the force-transmitting element has a shaft section whose one end is fixedly connected to the measuring roller.

5. The device according to claim 4, wherein the loading shoulder is constructed as a collar which encircles the shaft section.

6. The device according to claim 1, wherein the measuring sensor and the force-transmitting element are arranged coaxially and the loading shoulder acts on the measuring sensor with its lower side facing away from the outside of the measuring roller.

7. The device according to claim 1, wherein the fixed connection between the force-transmitting element and the measuring roller is formed by a screw connection.

8. The device according to claim 1, wherein both the cover and the force-transmitting element are constructed in one piece.

9. The device according to claim 1, wherein the loading shoulder, the supporting shoulder and the cover integrally form a body which is coupled to the measuring roller via a shaft detachably connected to the body.

10. The device according to claim 1, wherein the cover and the supporting shoulder integrally form a body which is supported on the shaft detachably connected to the body.

11. The device according to claim 1, wherein the force-transmitting element and/or the cover have shaped elements which bring about a directional introduction of forces acting on the cover onto the force-transmitting element.

12. The device according to claim 1, wherein cover has a substantially constant thickness at least in its region projecting over the supporting shoulder.

13. The device according to claim 1, wherein the thickness of the cover increases in the direction of the supporting shoulder.

14. The device according to claim 1, wherein the thickness of the cover decreases in the direction of the supporting shoulder.

15. The device according to claim 1, wherein between the force-transmitting element and the wall of the receptacle surrounding said force-transmitting element, there is a sealing element by which means a space existing between the cover and the sealing element is sealed towards the measuring sensor.

16. The device according to claim 1, wherein the force-transmitting element has at least one section which consists of a different material than the section of the force-transmitting element adjacent thereto.

17. The device according to claim 1, wherein the cover consists of a material whose properties differ from those of the material from which the shaft of the force-transmitting element is made.

18. The device according to claim 1, wherein the receptacle has a circular cross-section.

19. The device according to claim 1, wherein the cover is connected to the force-transmitting element by means of a press connection.
